(19) United States
(12) Patent Application Publication
(10) Pub. No.: US 2025/0341427 A1
(43) Pub. Date: Nov. 6, 2025

(54) Wireless Temperature Probe

(71) Applicant: Weber-Stephen Products LLC, Palatine, IL (US)

(72) Inventors: Gabriel Risk, San Francisco, CA (US); Nicholas Beyrer, San Francisco, CA (US); Heston Liebowitz, Colorado Springs, CO (US)

(21) Appl. No.: 19/194,619

(22) Filed: Apr. 30, 2025

Related U.S. Application Data
(60) Provisional application No. 63/641,197, filed on May 1, 2024.

(51) Int. Cl. G01K 1/024; G01K 1/02; G01K 7/02; G01K 7/22

(52) U.S. Cl. CPC G01K 1/024; G01K 1/026; G01K 7/02; G01K 7/22; G01K 2215/00

(57) ABSTRACT

The present disclosure describes a wireless temperature probe comprising a hollow metal body, internal circuitry, and a handle. The circuitry comprises a first sensor configured to measure a first internal temperature of a food as the food cooks, one or more sensors configured to measure a second internal temperature of a food as the food cooks, a second sensor configured to measure an ambient temperature of a cooking chamber, a battery, a printed circuit board comprising at least one processor and memory, an antenna, and a connector configured to be communicatively coupled to an external charging terminal. The internal circuitry is configured to fit into the hollow internal portion of the metal body. The wireless temperature probe is configured to monitor an internal temperature of a food as the food cooks and periodically transmit the internal temperature of the food to a computing device.

### CROSS-REFERENCE TO RELATED APPLICATIONS

This application claims the benefit of U.S. Provisional Application No. 63/641,197, filed May 1, 2024, the entirety of which is hereby incorporated by reference for all purposes.

### TECHNICAL FIELD

Aspects of the disclosure generally relate to wireless temperature probes. Additional aspects of the disclosure generally relate to methods and systems for monitoring internal temperatures of food using wireless temperature probes.

### BACKGROUND OF THE INVENTION

Cooking food, and especially meat, to specific internal temperatures may kill harmful germs that can cause food poisoning. However, constantly opening up grill covers and oven doors to check internal temperatures releases heat, which prolongs the cooking time and dries out food. While wired temperature probes may monitor internal temperatures of food while it cooks, wired temperature probes can interfere when flipping and/or turning food. This is especially true when wired temperature probes are used for rotisserie cooking.

### SUMMARY OF THE INVENTION

The following presents a simplified summary of various features described herein. This summary is not an extensive overview, and is not intended to identify key or critical elements or to delineate the scope of the claims. The following summary merely presents some concepts in a simplified form as an introductory prelude to the more detailed description provided below. Corresponding apparatus, systems, and computer-readable media are also within the scope of the disclosure.

Aspects of the disclosure generally relate to wireless temperature probes and methods and systems for monitoring internal temperatures of food using wireless temperature probes. According to certain aspects of the disclosure, wireless temperature probes may be used to monitor internal temperatures of food while it cooks. The wireless temperature probes described herein may comprise a hollow metal body (alternatively, referred to as a needle), circuitry, and a handle. The circuitry comprises a plurality of temperature sensors, a battery, a printed circuit board comprising at least one processor and memory, an antenna, and/or a charging cap configured to be communicatively coupled to an external charging terminal. The circuitry is configured to fit into the internal portion of the hollow metal body. The handle is configured to connect to the metal body to encapsulate the circuitry in the handle and the hollow metal body, thereby forming an integral unit.

In operation, the wireless temperature probe may be inserted into food to monitor the internal temperature of the food as it cooks. Preferably, the wireless temperature probe may be inserted into the food up to the handle and/or to a taper of the metal body, proximately located near, or next to, the handle. The wireless temperature probe may be configured to monitor the internal temperature of the food and periodically transmit, via the antenna, the internal temperature to a device, such as a display device, a mobile device, a wearable device (e.g., a smart watch, augmented reality (AR) goggles, etc.), a grill, an oven, or the like.

These features, along with many others, are discussed in greater detail below.

### BRIEF DESCRIPTION OF DRAWINGS

The present disclosure is described by way of example and not limited in the accompanying figures in which like reference numerals indicate similar elements and in which:

FIGS. 1A-1G show various perspectives of a wireless temperature probe in accordance with one or more aspects of the disclosure;

FIG. 2 shows an example of a process of using the wireless temperature probe to monitor internal cooking temperatures in accordance with one or more aspects of the disclosure;

FIG. 3 shows an example of an environment where a wireless temperature probe may be used;

FIG. 4 shows an example of a display for monitoring internal cooking temperatures in accordance with one or more aspects of the disclosure;

FIG. 5 shows an example of monitoring internal cooking temperatures using a mobile device in accordance with one or more aspects of the disclosure; and

FIG. 6 shows an example of monitoring internal cooking temperatures using a wearable device in accordance with one or more aspects of the disclosure.

### DETAILED DESCRIPTION OF THE INVENTION

In the following description, reference is made to the accompanying drawings, which form a part hereof, and in which are shown various examples of features of the disclosure and/or of how the disclosure may be practiced. It is to be understood that other features may be utilized and structural and functional modifications may be made without departing from the scope of the present disclosure. The disclosure may be practiced or carried out in various ways. In addition, it is to be understood that the phraseology and terminology used herein are for the purpose of description and should not be regarded as limiting. Rather, the phrases and terms used herein are to be given their broadest interpretation and meaning.

By way of introduction, features discussed herein may relate to wireless temperature probes and methods and systems for monitoring internal temperatures of food while it cooks using wireless temperature probes. The wireless temperature probes described herein may comprise a hollow metal body (alternatively, referred to as “a needle”), circuitry, and a handle. The circuitry comprises a first sensor configured to measure a first temperature of food, a second sensor configured to measure an ambient temperature of a cooking chamber, at least one temperature sensor configured to measure a second temperature of the food, a battery, a printed circuit board comprising at least one processor and memory, an antenna, and/or a charging cap. The first sensor and the at least one temperature sensor may monitor the first temperature and the second temperature. The first sensor and the at least one temperature sensor may provide the first temperature and the second temperature to the processor, which may determine an internal temperature of the food based on the first temperature and the second temperature. The processor may cause the internal temperature to be transmitted (e.g., sent), via the antenna, to a computing device and/or a display, such as a mobile device, a wearable device (e.g., a smart watch, AR goggles, etc.), a display of a grill, a display of an oven. or the like.

As noted above, the second sensor may measure an ambient temperature of a cooking chamber (e.g., grill, smoker, oven, etc.). The second sensor may provide the ambient temperature of the cooking chamber to the processor. The processor may cause the ambient temperature of the cooking chamber to be transmitted (e.g., sent), via the antenna, to the computing device and/or the display.

By using the wireless temperature probes described herein, an internal temperature of food may be monitored without having to open up a grill cover or oven door or getting in the way when flipping food or when food is cooked on a rotisserie. This improves the efficiency of the cooking vessel since less heat will be lost through opening up a grill cover or an oven door. Moreover, the wireless temperature probes allow for the monitoring of food at high temperatures (e.g., >315° C. (600° F.)). Furthermore, the wireless temperature probes described herein are less cumbersome to use than wired temperature probes and allow for measuring foods in situations where a wire would get in the way (e.g., on a very big grill, on a rotisserie, while sealed in a pressure vessel, etc.). Finally, the wireless temperature probes described herein ensure that food is cooked to a target temperature, thereby reducing the likelihood that food will be overcooked and/or inedible.

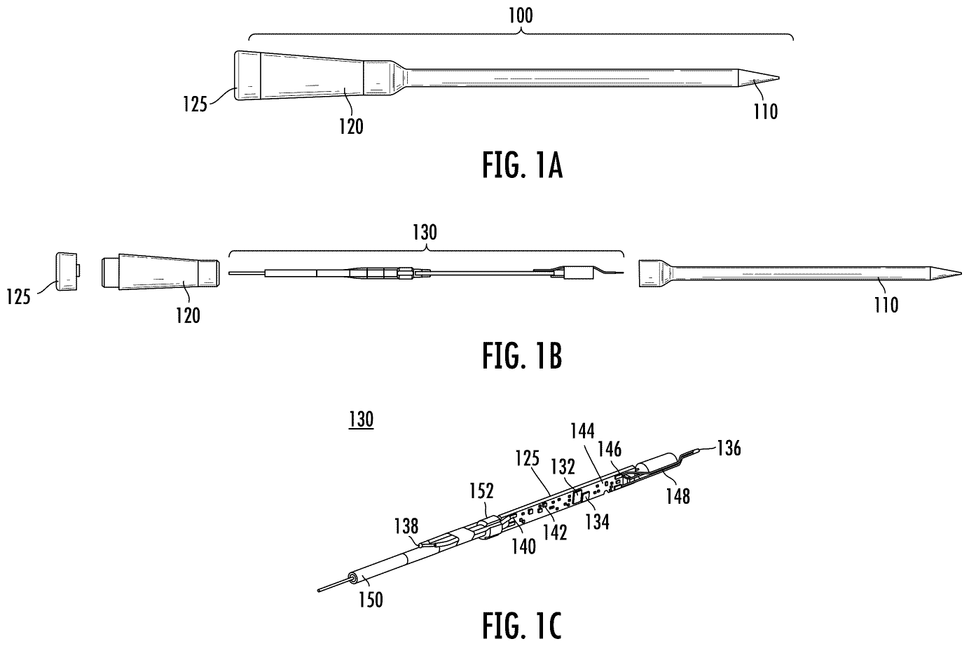

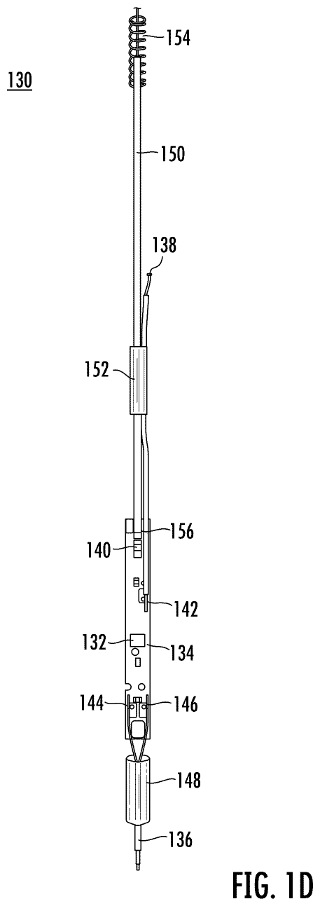

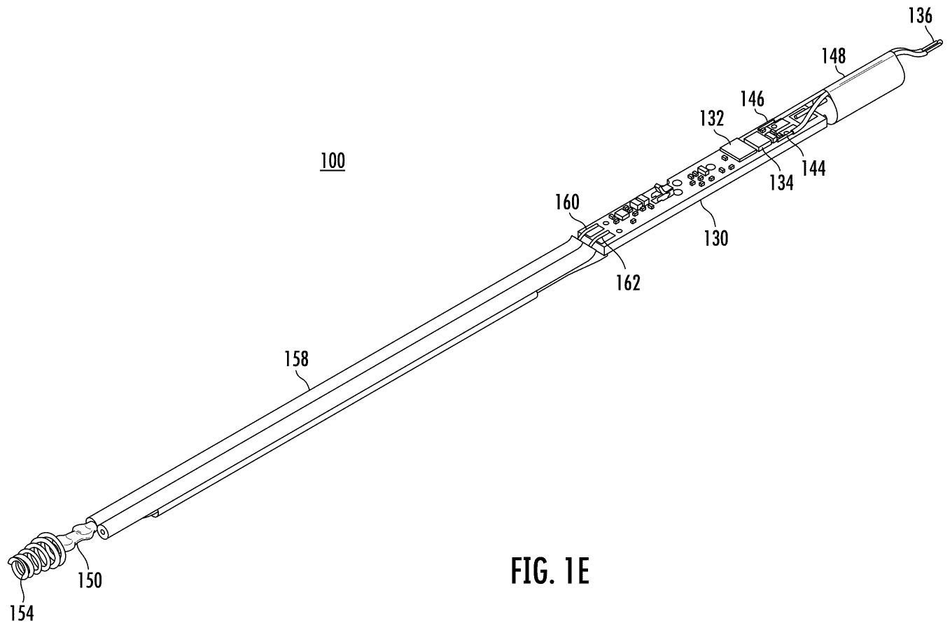

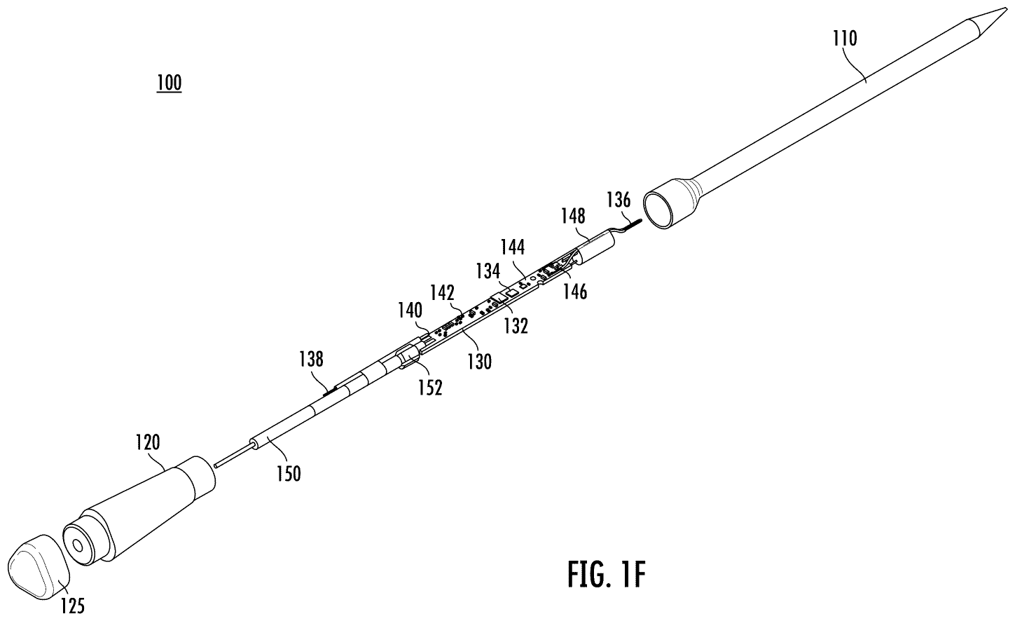

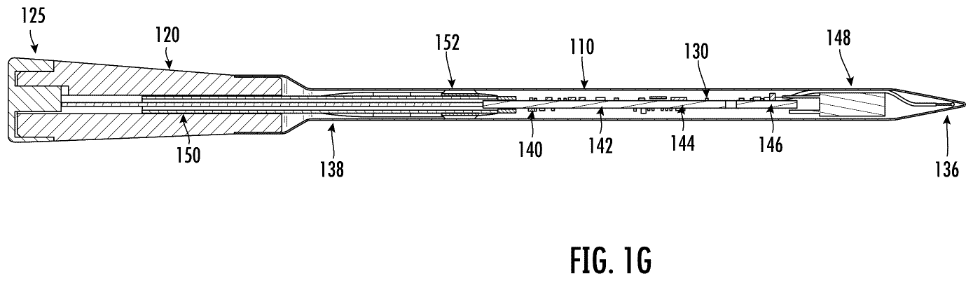

FIGS. 1A-1G show various perspectives of a wireless temperature probe 100 in accordance with one or more aspects of the disclosure. As shown in FIGS. 1A-1G, wireless temperature probe 100 comprises a needle 110, a handle 120, a charging cap 125, and circuitry 130, which may be encapsulated by needle 110, handle 120, and/or charging cap 125.

Needle 110 may be a hollow cylindrical body with a closed distal end and an open proximal end. The closed distal end may be conical in shape. The closed distal end may be configured to be inserted into a food during cooking. Needle 110 may be made of any suitable material. Preferably, needle 110 is made from stainless steel (e.g., SS304) due to stainless steel's high resistance to corrosion and malleability for ease of fabrication. Needle 110 may have an inner diameter between approximately 2 millimeters (mm) and 5 mm, and preferably approximately 3.9 mm. The outer diameter of needle 110 may be between 3.5 mm and 6 mm, and preferably approximately 4.5 mm.

Circuitry 130 may comprise a printed circuit board comprising processor 132, memory (not shown), and a clock 134. First sensor 136, second sensor 138, and/or the one or more temperature sensors (e.g., first temperature sensor 140, second temperature sensor 142, third temperature sensor 144, fourth temperature sensor 146) may also be communicatively coupled to the printed circuit board. The printed circuit board may be made from any suitable dielectric material, including, for example, FR4. The printed circuit board may be configured to operate at a wide range of temperatures, including those achieved by home grills and ovens. In some instances, an insulating material may be placed between the printed circuit board and an inner diameter of needle 110. The insulating material may be a foam, a gel, or any other suitable material capable of providing insulation between the inner diameter of needle 110 and the printed circuit board. In some examples, the printed circuit board may comprise a printed circuit board and a ceramic circuit board. The ceramic circuit board may comprise antenna 150, discussed in greater detail below. In these examples, the printed circuit board and the ceramic circuit board may be connected via an assembly.

Processor 132 may be any suitable processor, such as a single-core or multi-core processor, or may include multiple CPUs. In some examples, processor 132 may include a low-power processor and/or microcontroller, such as an Advanced RISC Machine (ARM) processor and/or any suitable field programmable array (FPGA), application specific integrated circuit (ASIC), or system on a chip (SOC). Processor 132, and associated components described herein, may execute a series of computer-readable instructions (e.g., instructions stored in memory) to perform some or all of the processes described herein.

Memory may be any suitable memory capable of storing instructions to be executed by processor 132 and/or one or more temperatures provided by first sensor 136, second sensor 138, and/or one or more temperature sensors (e.g., first temperature sensor 140, second temperature sensor 142, third temperature sensor 144, fourth temperature sensor 146). Memory may be internal to processor 132. Memory may comprise volatile and nonvolatile, non-removable media implemented in any method or technology for storage of information such as computer-readable instructions, data structures, program modules, or other data. Memory may comprise one or more physical persistent memory devices and/or one or more non-persistent memory devices. Memory may comprise random access memory (RAM), read only memory (ROM), electronically erasable programmable read only memory (EEPROM), flash memory or other memory technology or any other medium that may be used to store the desired information and that may be accessed by processor 132.

Clock 134 may be an oscillator configured to generate clock frequencies for operation of wireless temperature probe 100. Preferably, clock 134 is a crystal oscillator. Clock 134 may have an adjustable frequency. Clock 134 may have high heat resistance.

First sensor 136 may be configured to measure (e.g., monitor, detect) an internal temperature of a food. First sensor 136 may be located in the closed distal end of needle 110. First sensor 136 may be small enough to fit in the tip of the needle to allow for battery 148 to fit between first sensor 136 and circuitry 130 (i.e., the printed circuit board). That is, first sensor 136, and the wiring associated therewith, may be small enough such that battery 148 may fit between first sensor 136 and circuitry 130 (i.e., the printed circuit board). In this regard, first sensor 136 may comprise a thermocouple. Alternatively, first sensor 136 may comprise a thermistor (e.g., a negative temperature coefficient (NTC) thermistor), such as an NTC thermistor printed on a flexible printed circuit board. In these examples the flexible printed circuit board may be approximately 0.15 millimeters (mm) in order to accommodate battery 148 being between first sensor 136 and circuitry 130. First sensor 136 may be configured to measure an internal temperature of food. Additionally or alternatively, needle 110 may pierce the food and/or come in contact with bones, which may expose first sensor 136 to higher temperatures than typically encountered when cooking food. Because of this, first sensor 136 may be configured to measure temperatures up to 260° C. (500° F.). In operation, first sensor 136 may measure temperatures up to 100° C. (212° F.) due to first sensor 136's proximity to battery 148.

Second sensor 138 may be configured to measure (e.g., monitor, detect) an ambient temperature of a cooking temperature. Second sensor 138 may be located near the open proximal end of needle 110. The open proximal end of needle 110 may be tapered to better engage and/or connect with handle 120. Second sensor 138 may be located in, or near, the tapered portion of needle 110. Second sensor 138 may be configured to measure an ambient temperature of the cooking chamber (e.g., grill, smoker, oven, etc.). Second sensor 138 may be configured to measure temperatures up to 450° C. (842° F.). Second sensor 138 may comprise a thermocouple, a thermistor (e.g., negative temperature coefficient (NTC) thermistor), or any suitable equivalent thereof.

Wireless temperature probe 100 may comprise one or more temperature sensors (e.g., first temperature sensor 140, second temperature sensor 142, third temperature sensor 144, fourth temperature sensor 146). The one or more temperature sensors (e.g., first temperature sensor 140, second temperature sensor 142, third temperature sensor 144, fourth temperature sensor 146) may be any suitable sensor for measuring the internal temperature of the food. The one or more temperature sensors (e.g., first temperature sensor 140, second temperature sensor 142, third temperature sensor 144, fourth temperature sensor 146) may be thermistors and, preferably, negative temperature coefficient (NTC) thermistors. The one or more temperature sensors (e.g., first temperature sensor 140, second temperature sensor 142, third temperature sensor 144, fourth temperature sensor 146) may be located throughout needle 110. In some instances, the one or more temperature sensors (e.g., first temperature sensor 140, second temperature sensor 142, third temperature sensor 144, fourth temperature sensor 146) may be distributed at equidistance throughout needle 110. Each of the one or more temperature sensors (e.g., first temperature sensor 140, second temperature sensor 142, third temperature sensor 144, fourth temperature sensor 146) may be configured to measure temperatures up to 150° C. (300° F.). By using a plurality of temperature sensors, a more accurate reading of the internal temperature of the food may be obtained. For example, first sensor 136 may not be located in the center of the food. Alternatively, first sensor 136 may be closed to a bone or other tissue. In both scenarios, first sensor 136 may provide an inaccurate reading of the temperature of the food. The plurality of sensors described herein may obtain multiple measurements, at different locations throughout the food, thereby ensuring an accurate and even internal cooking temperature is obtained.

Battery 148 may be configured to provide power to wireless temperature probe 100. Battery 148 may be a rechargeable battery, a capacitor, a supercapacitor, or any equivalent thereof. Battery 148 may have a rating between 0.5 milliampere-hour (mAh) and 5.0 mAh. Preferably, battery 148 has a rating of approximately 0.8 mAh. Battery 148 may have a diameter between 2 mm and 5 mm to fit within the inner diameter of needle 110. A diameter between 2 mm and 5 mm would provide sufficient room to allow wires (e.g., leads) to connect first sensor 136 to the printed circuit board. Preferably, battery 148 has a diameter of approximately 3.3 mm, +/−1-2 mm.

Antenna 150 may be any suitable transceiver configured to transmit signals to one or more computing devices. Antenna 150 may be made from any suitable material. For example, antenna 150 may be a ceramic antenna, for example, similar to the embodiment depicted in FIG. 1D. The use of a ceramic antenna may include a notch in antenna 150, such as notch 156. Notch 156 connect antenna 150 to the PCB at a 90-degree angle. The interconnection of antenna 150 and the PCB at a 90-degree angle, via notch 156, may provide additional structural support to wireless temperature probe 100. According to other examples, antenna 150 may comprise a shielded transmission line, for example, as shown in FIG. 1E. As shown in FIG. 1E, antenna 150 may comprise waveguide 158 that does not use an outer sheath or any type of tunneling. Antenna 150 may comprise two grounds (e.g., first ground 160, second ground 162). First ground 160 may be configured to form waveguide 158 around antenna 150. In yet further examples, antenna 150 may comprise a wire. The wire may be a unique shape. Antenna 150 may be produced from any malleable metal (e.g., a copper wire). The wire may be any suitable thickness and, preferably, either 18-gauge or 20-gauge wire. When antenna 150 is a wire, a sheath (e.g., waveguide 158) may be used to form a shield and/or waveguide. According to some examples, antenna 150 may be a half-wave dipole antenna, such as a coaxial antenna. Antenna 150 may be configured to transmit signals using a short-range wireless communication protocol, such as Bluetooth®, Zigbee, Z-Wave, ANT, LoRa, or any equivalent thereof. Additionally or alternatively, antenna 150 may be configured to transmit signals using wireless communication protocols, such as IEEE 802.11, WiFi, and the like. In some implementations, antenna bumper 152 may be included in the circuitry. Antenna bumper 152 may be configured to secure antenna 150 in position. Additionally or alternatively, antenna bumper 152 may be configured to organize and/or secure wires, such as the wires connecting second sensor 138 to the printed circuit board.

Spring 154 may be configured to keep circuitry 130 securely in place in needle 110. In this regard, spring 154 may be between charging terminal 125 and ceramic antenna 150. Spring 154 may provide compression loading for the circuitry 130.

Handle 120 may be configured to attach (e.g., connect) to needle 110. Handle 120, when attached to needle 110, may secure circuitry 130 in place inside needle 110. Handle 120 may be configured to be external to the food, while needle 110 is inserted into the food to monitor the temperature of the food. Handle 120 may be made of any suitable material, such as ceramic. In particular, handle 120 may be made from materials that have low thermal conductivity and high strength. Materials for handle 120 should be resistant to crack propagation and have a high fracture toughness. Preferably, handle 120 is made from zirconium dioxide (ZrO₂) or an equivalent material.

Charging cap 125 may be configured to provide an electrical charge to battery 148. Charging cap 125 may interface with one or more charging stations to provide an electrical charge to battery 148, via one or more leads and/or electrical connections. Charging cap 125 may be made from any suitable material. Charging cap 125 may comprise one or more contacts for connecting to (e.g., interfacing with) the one or more charging stations. While charging cap 125 is shown as being attached to the handle, charging cap 125 may be located anywhere in wireless temperature probe 100, including in the tip (e.g., the closed conical tip) or anywhere along needle 110. By allowing charging through other portions of wireless temperature probe (i.e., not via antenna 150), wireless temperature probe 100 may be able to communicate with external devices while being charged.

The wireless temperature probe shown in FIGS. 1A-1G may minimize, or reduce, the need to open grill covers and/or oven doors to monitor, or measure, the internal temperature of the food as it is being cooked. Further, wireless temperature probes do not interfere when food needs to be turned or flipped or when food is cooked on a rotisserie, the way wired temperature probes do. The wireless temperature probe may monitor food being cooked at high temperatures (e.g., >315° C. (600° F. Moreover, the wireless temperature probes described herein are less cumbersome to use than wired temperature probes and allow for measuring foods in situations where a wire would get in the way (e.g., on a very big grill, on a rotisserie, while sealed in a pressure vessel, etc.).

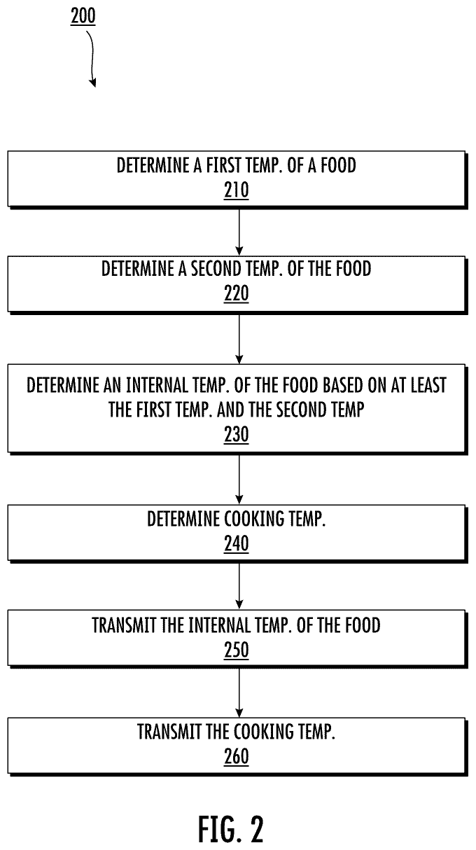

FIG. 2 shows an example of a process of using the wireless temperature probe to monitor internal cooking temperatures of food in accordance with one or more aspects of the disclosure. In step 210, a wireless temperature probe (e.g., wireless temperature probe 100) may determine a first temperature of a food. The first temperature may be received from a first sensor, such as first sensor 136 discussed above. In particular, a processor of the wireless temperature probe may receive the first temperature from first sensor 136. The first temperature may be stored in a memory location, such as memory, a cache, or another temporary storage.

In step 220, the wireless temperature probe may determine a second temperature of the food. The second temperature may be received from one or more temperature sensors, such as first temperature sensor 140, second temperature sensor 142, third temperature sensor 144, and/or fourth temperature sensor 146. In particular, the processor of the wireless temperature probe may receive the second temperature from the one or more temperature sensors. The second temperature may be stored in a memory, similar to the first temperature discussed above.

In step 230, the wireless temperature probe may determine an internal temperature of a food. The internal temperature of the food may be based on at least the first temperature and the second temperature. The internal temperature may be calculated as the average or the median of the first temperature and the second temperature. Additionally or alternatively, the internal temperature may be the lower (or lowest) temperature of the measured temperatures. In further examples, the internal temperature may be an intermediate temperature computed using a proprietary algorithm. As noted above, by using multiple temperatures obtained from one or more temperature sensors, a more accurate reading of the internal temperature of the food may be determined. That is, the plurality of sensors described herein may obtain multiple measurements, at different locations throughout the food, thereby ensuring an accurate and even internal cooking temperature is calculated.

In step 240, the wireless temperature probe may determine an ambient temperature of a cooking chamber. The ambient temperature may be received from a second sensor, such as second sensor 138. As discussed above, the processor of the wireless temperature probe may receive the ambient temperature from the second sensor and store the ambient temperature in a memory. As noted above, the cooking chamber may be a grill, a smoker, an oven, or any equivalent thereof.

In step 250, the wireless temperature probe may transmit (e.g., send) the internal temperature of the food to one or more computing devices. The one or more computing devices may include a display device, a mobile device, a wearable device (e.g., a smart watch, AR goggles, etc.), a grill, an oven, or the like. The one or more computing devices may display the internal temperature of the food. Preferably, the wireless temperature probe may send the internal temperature to the one or more computing devices using any suitable wireless communication protocol discussed above.

In step 260, the wireless temperature probe may transmit (e.g., send) the ambient temperature of the cooking chamber to the one or more computing devices. The one or more computing devices may display the ambient temperature of the cooking chamber. The internal temperature of the food and the ambient temperature of the cooking chamber may be displayed concurrently. Alternatively, the internal temperature of the food and the ambient temperature of the cooking chamber may be displayed in an alternating pattern. Similar to the transmission of the internal temperature of the food, the wireless temperature probe may send the ambient temperature to the one or more computing devices via any suitable wireless communication protocol.

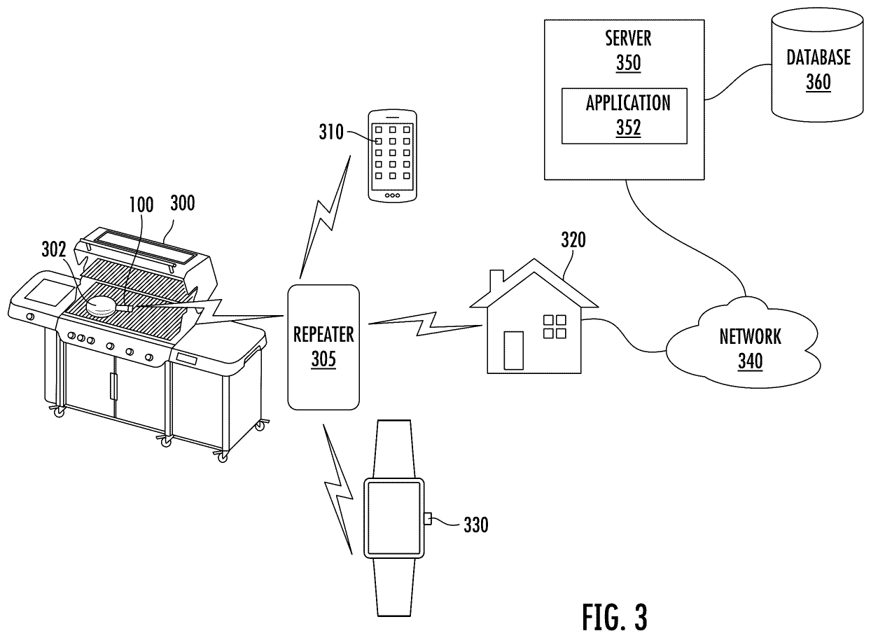

FIG. 3 shows an example of an environment where a wireless temperature probe may be used. The environment includes grill 300, user device 110, home network 320, and wearable device 330. Home network 320 may be connected to server 350 via network 340. Server 350 may include database 360.

As shown in FIG. 3, food 302 may be cooking on grill 300. Wireless temperature probe 100 may be inserted food 302, as it cooks, to monitor the internal temperature of food 302. While a grill is shown in FIG. 3, it will be appreciated that any suitable cooking tool, such as a smoker, an oven, etc., may be used in its place. Using the techniques described above, wireless temperature probe may transmit (e.g., send) the internal temperature of food 302, the ambient temperature (e.g., cooking temperature) of grill 300, or both, to user device 110, wearable device 330, and/or server 350 via home network 320 and/or network 340. In some instances, the internal temperature of food 302, the ambient temperature (e.g., cooking temperature) of grill 300, or both, may be sent to the devices via repeater 305.

Repeater 305 may be a range extender for wireless temperature probe 100. Additionally or alternatively, repeater 305 may be used to charge wireless temperature probe 100 when it is not being used. That is, repeater 305 may have a receiving interface to receive charging cap 125.

Repeater 305 may comprise a first interface to receive wireless communications from wireless temperature probe 100. Repeater 305 may comprise a second interface to send wireless communications to one or more devices. In some instances, the first interface and the second interface may be the same interface. In other examples, the first interface and the second interface are different interfaces. The first interface may be configured to receive electronic communications using a short-range wireless communication protocol, such as Bluetooth®, Zigbee, Z-Wave, ANT, LoRa, or any equivalent thereof. The second interface may be configured to send electronic communications and/or signals using wireless communication protocols, such as IEEE 802.11, WiFi, GSM, CDMA, and the like.

User device 310 may be a mobile device, such as a cellular phone, a mobile phone, a smart phone, a tablet, a laptop, or the like. Alternatively, user device 310 may be any suitable internet-enabled device, such as a smart speaker, smart television, or the like. User device 310 may have one or more applications stored thereon. A first application, of the one or more applications, may be configured to receive and display the internal temperature of food 302, the ambient temperature (e.g., cooking temperature) of grill 300, or both. In some instances, the first application may be configured to generate an alert when food 302 reaches a target temperature. The alert may be an audible alert, a visual alert, a tactile alert, or any combination thereof.

Wearable device 330 may be a device worn and/or attached to a user. In this regard, wearable device may be a smart watch, a fitness tracker, AR goggles, etc. The wearable device 330 may have one or more applications or applets that are configured to receive and display the internal temperature of food 302, the ambient temperature (e.g., cooking temperature) of grill 300, or both. The one or more applications may be configured to generate an alert when food 302 reaches a target temperature. The alert may be an audible alert, a visual alert, a tactile alert, or any combination thereof

Server 350 may be any server capable of executing application 352. As noted above, server 350 may be communicatively coupled to database 360. Server 350 may be a stand-alone server, a corporate server, or a server located in a server farm or cloud-computer environment. According to some examples, server 350 may be a virtual server hosted on hardware capable of supporting a plurality of virtual servers.

Application 352 may be server-based software configured to receive the internal temperature of food 302, the ambient temperature (e.g., cooking temperature) of grill 300, or both. Application 352 may be configured to send receive and display the internal temperature of food 302, the ambient temperature (e.g., cooking temperature) of grill 300, or both, to user device 310 and/or wearable device 330. Application 352 may send receive and display the internal temperature of food 302, the ambient temperature (e.g., cooking temperature) of grill 300, or both via one or more electronic communications, such as a text message, a push notification, etc.

Database 360 may be configured to store information on behalf of application 352. The information may include, but is not limited to, personal information and/or account information for a user. Database 150 may include, but is not limited to, relational databases, hierarchical databases, distributed databases, in-memory databases, flat file databases, XML databases, NoSQL databases, graph databases, and/or a combination thereof.

Network 340 may include any type of network. In this regard, network 340 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and cardholders to support input, extraction, and manipulation of data between the various computing devices. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls.

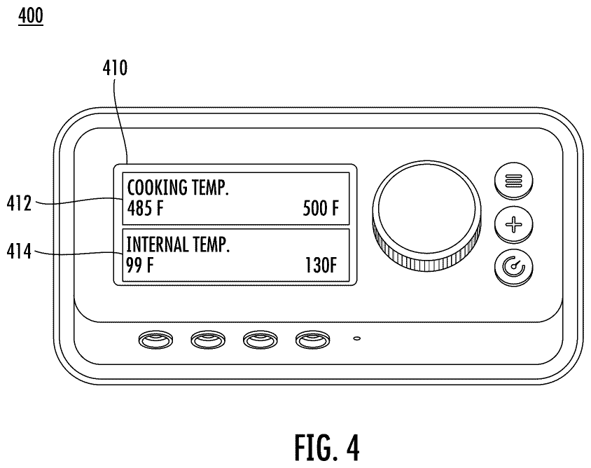

FIG. 4 shows an example of a display for monitoring internal cooking temperatures in accordance with one or more aspects of the disclosure. Interface 400 may be part of a grill, oven, smoker, etc. Alternatively, Interface 400 may be associated with a device configured to monitor cooking temperatures, similar to the Weber Connect® Smart Grilling Hub. Interface 400 may comprise a display 410. Display 410 may comprise a liquid crystal display (LCD) display technology, a light emitting diode (LED) display technology, vacuum florescent display technology, and/or the like. Display 410 may be configured to first field 412 configured to display the ambient temperature and/or a second field 414 configured to display the internal temperature of food. First field 412 may present both the actual temperature (e.g., 485° F.) and the target temperature (e.g., 500° F.). Similarly, second field 414 may present the actual temperature of the food (e.g., 99° F.) and the target temperature of the food (e.g., 130° F.).

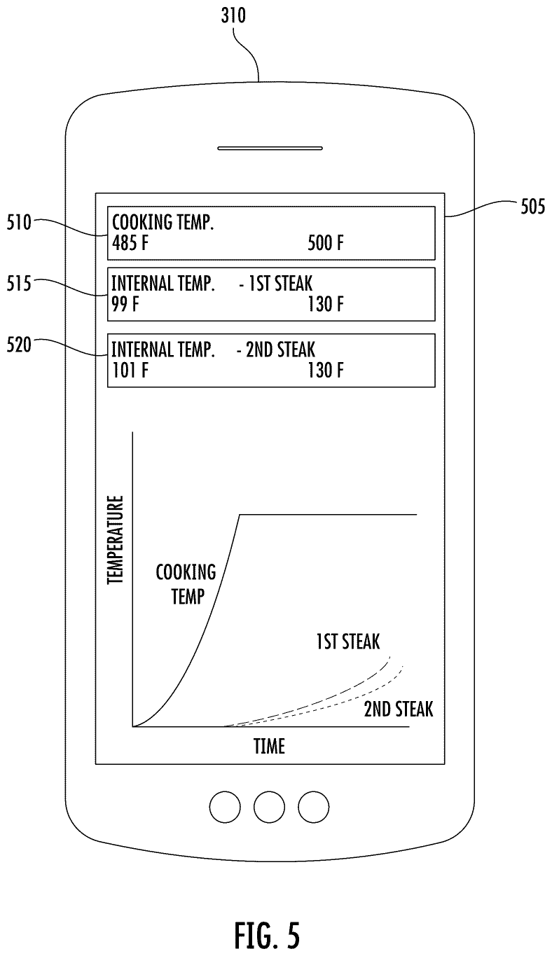

FIG. 5 shows an example of monitoring internal cooking temperatures using user device 310 in accordance with one or more aspects of the disclosure. User device 310 may comprise a first interface 505. First interface 505 may be associated with a mobile application configured to monitor the ambient temperature of a cooking chamber, the internal temperature of food, or both. First interface 505 may comprise a first field 510 configured to display an ambient temperature of the cooking chamber, a second field 515 configured to display a first internal temperature of a first food (e.g., 1^{st} steak), and a third field 520 configured to display a second internal temperature of a second food (e.g., 2^{nd} steak). First field 510 may present both the actual temperature (e.g., 485° F.) and the target temperature (e.g., 500° F.). Second field 515 may present the actual temperature of a first food (e.g., 99° F.) and the target temperature of the first food (e.g., 130° F.). Third field 520 may present the actual temperature of the second food (e.g., 101° F.) and the target temperature of the second food (e.g., 130° F.). FIG. 5 shows that a plurality of wireless temperature probes may be used simultaneously to monitor the cooking temperature of different food items. Using the mobile application on the user device 310, a user may synchronize a plurality of wireless temperature probes with the mobile application, which may then be used to monitor the cooking temperature of different foods.

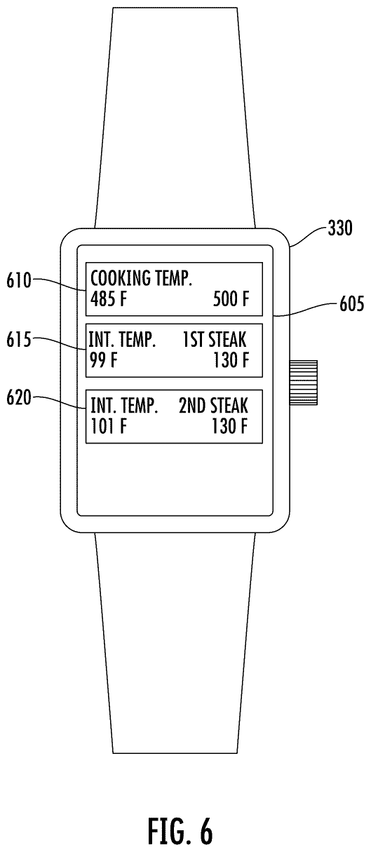

FIG. 6 shows an example of monitoring internal cooking temperatures using a wearable device 330 in accordance with one or more aspects of the disclosure. Wearable device 330 may comprise a first interface 605. First interface 605 may be associated with the mobile application executing on user device 310. Additionally or alternatively, first interface 605 may be associated with a second mobile application executing on the wearable device. The second mobile application may be configured to monitor the ambient temperature of a cooking chamber, the internal temperature of food, or both. Similar to the previously described interfaces, first interface 605 may comprise a first field 610 configured to display an ambient temperature of the cooking chamber, a second field 615 configured to display a first internal temperature of a first food (e.g., 1^{st} steak), and a third field 620 configured to display a second internal temperature of a second food (e.g., 2^{nd} steak). First field 610 may display both the actual temperature (e.g., 485° F.) and the target temperature (e.g., 500° F.). Second field 615 may present the actual temperature of a first food (e.g., 99° F.) and the target temperature of the first food (e.g., 130° F.). Third field 620 may display both the actual temperature of the second food (e.g., 101° F.) and the target temperature of the second food (e.g., 130° F.).

The above-described devices, systems, and methods may improve the efficiency of cooking vessels by eliminating the need to open grill covers and/or oven doors to monitor, or measure, the internal temperature of the food as it is being cooked. Additionally, the wireless temperature probes may not interfere or get tangled when food is turned and/or flipped or cooked on a rotisserie, in the manner that wired temperature probes do. Further, the wireless temperature probes described herein may allow for the monitoring of food being cooked at high temperatures (e.g., >315° C. (600° F.)). Furthermore, the wireless temperature probes described herein are less cumbersome to use than wired temperature probes and allow for measuring foods in situations where a wire would get in the way (e.g., on a very big grill, on a rotisserie, while sealed in a pressure vessel, etc.). Finally, the wireless temperature probes described herein ensure that food is cooked to a target temperature, thereby reducing the likelihood that food will be overcooked and/or inedible.

One or more features discussed herein may be embodied in computer-usable or readable data and/or computer-executable instructions, such as in one or more program modules, executed by one or more computers or other devices as described herein. Program modules may comprise routines, programs, objects, components, data structures, and the like. that perform particular tasks or implement particular abstract data types when executed by a processor in a computer or other device. The modules may be written in a source code programming language that is subsequently compiled for execution, or may be written in a scripting language such as (but not limited to) Python, Perl, or any equivalent thereof. The computer executable instructions may be stored on a computer readable medium such as a hard disk, optical disk, removable storage media, solid-state memory, RAM, and the like. The functionality of the program modules may be combined or distributed as desired. In addition, the functionality may be embodied in whole or in part in firmware or hardware equivalents such as integrated circuits, field programmable gate arrays (FPGA), and the like. Particular data structures may be used to more effectively implement one or more features discussed herein, and such data structures are contemplated within the scope of computer executable instructions and computer-usable data described herein. Various features described herein may be embodied as a method, a computing device, a system, and/or a computer program product.

Although the present disclosure has been described in terms of various examples, many additional modifications and variations would be apparent to those skilled in the art. In particular, any of the various processes described above may be performed in alternative sequences and/or in parallel (on different computing devices) in order to achieve similar results in a manner that is more appropriate to the requirements of a specific application. It is therefore to be understood that the present disclosure may be practiced otherwise than specifically described without departing from the scope and spirit of the present disclosure. Although examples are described above, features and/or steps of those examples may be combined, divided, omitted, rearranged, revised, and/or augmented in any desired manner. Thus, the present disclosure should be considered in all respects as illustrative and not restrictive. Accordingly, the scope of the disclosure should be determined not by the examples, but by the appended claims and their equivalents.

1. A wireless temperature probe comprising:
a hollow needle configured to be inserted in food;
a ceramic handle configured to attach to the hollow needle;
a first sensor located in a tip of the hollow needle, wherein the first sensor is configured to measure a first temperature of the food;
a second sensor located in the hollow needle located proximately to the ceramic handle, wherein the second sensor is configured to measure an ambient temperature of a cooking chamber;
one or more sensors located throughout the hollow needle, wherein the one or more sensors are configured to measure a second temperature of the food;
a processor configured to determine an internal temperature of the food based on at least the first temperature and the second temperature; and
an antenna configured to transmit the internal temperature of the food.

2. The wireless temperature probe of claim 1, further comprising:
a charging terminal, wherein the charging terminal is located at one end of the ceramic handle, a tip of the hollow needle, or one or more locations of the hollow needle.

3. The wireless temperature probe of claim 2, further comprising:
a spring located between the charging terminal and the antenna, wherein the spring is configured to compress one or more internal components inside the hollow needle.

4. The wireless temperature probe of claim 1, wherein the first sensor comprises at least one of:
a thermocouple; or
a thermistor on a flexible printed circuit board.

5. The wireless temperature probe of claim 1, wherein:
the first sensor comprises a first thermocouple; and
the second sensor comprises a second thermocouple.

6. The wireless temperature probe of claim 1, further comprising:
a printed circuit board; and
a ceramic circuit board, wherein the printed circuit board and the ceramic circuit board are connected via an assembly.

7. The wireless temperature probe of claim 6, wherein the antenna comprises a ceramic antenna with a notch, wherein the printed circuit board and the ceramic antenna are connected at a 90-degree angle via the notch.

8. The wireless temperature probe of claim 1, wherein an inner diameter of the hollow needle is between 2 millimeters (mm) and 5 mm.

9. The wireless temperature probe of claim 1, further comprising:
a battery configured to provide power to the wireless temperature probe.

10. The wireless temperature probe of claim 9, wherein the battery is disposed between the first sensor and a printed circuit board.

11. The wireless temperature probe of claim 1, further comprising:
a capacitor configured to provide power to the wireless temperature probe.

12. The wireless temperature probe of claim 1, wherein the antenna is further configured to transmit the ambient temperature of the cooking chamber.

13. The wireless temperature probe of claim 1, further comprising:
a printed circuit board; and
an insulating material between the printed circuit board and an inner diameter of the hollow needle.

14. The wireless temperature probe of claim 13, wherein the insulating material comprises at least one of:
a foam; or
a gel.

15. A system comprising:
a wireless temperature probe comprising:
a hollow needle configured to be inserted in food;
a ceramic handle configured to attach to the hollow needle;
a first sensor located in a tip of the hollow needle, wherein the first sensor is configured to measure a first temperature of the food;
a second sensor located in the hollow needle located proximately to the ceramic handle, wherein the second sensor is configured to measure an ambient temperature of a cooking chamber;
one or more sensors located throughout the hollow needle, wherein the one or more sensors are configured to measure a second temperature of the food;
a processor configured to determine an internal temperature of the food based on at least the first temperature and the second temperature; and
an antenna configured to transmit the internal temperature of the food; and
a computing device configured to:
receive the internal temperature of the food; and
display the internal temperature of the food.

16. The system of claim 15, further comprising:
a repeater configured to:
receive, from the wireless temperature probe, the internal temperature of the food; and
transmit, to the computing device, the internal temperature of the food.

17. The system of claim 15, further comprising:
a server configured to:
receive, from the wireless temperature probe, the internal temperature of the food; and
transmit, to the computing device, the internal temperature of the food.

18. The system of claim 17, wherein the server is further configured to transmit, to the computing device, an electronic communication with the internal temperature of the food, wherein the electronic communication comprises at least one of:
a text message; or
a push notification.

19. The system of claim 15, wherein the computing device comprises at least one of:
a display device;
a mobile device;
a wearable device;
a grill; or
an oven.

20. The system of claim 15, wherein the computing device is further configured to generate an alert when the internal temperature reaches a target temperature, wherein the alert comprises at least one of:
an audible alert;
a visual alert; or
a tactile alert.
